(19) United States
(12) Patent Application Publication
(10) Pub. No.: US 2026/0212188 A1
(43) Pub. Date: Jul. 23, 2026

(54) AUGMENTING MACHINE LEARNING MODELS

(71) Applicant: GOOGLE LLC, Mountain View, CA (US)

(72) Inventors: Milad Eftekhar, Mountain View, CA (US); Jingye Tian, Sunnyvale, CA (US)

(21) Appl. No.: 18/858,193

(22) PCT Filed: Sep. 11, 2024
(86) PCT No.: PCT/US2024/046163

§ 371 Date: Oct. 18, 2024

Related U.S. Application Data
(60) Provisional application No. 63/589,434, filed on Oct. 11, 2023.

(51) Int. Cl. G06N 3/0895; G06N 3/045

(52) U.S. Cl. CPC G06N 3/0895; G06N 3/045

(57) ABSTRACT

Methods, systems, and apparatus, including computer programs encoded on a computer storage medium, for augmenting a machine learning model. The methods comprise obtaining a set of features including two or more features, generating an embedding of each feature in the set of features, aggregating the embedding of each feature in the set of features to create an aggregated embedding representing the set of features as a whole, and augmenting the machine learning model based on the aggregated embedding representing the set of features as a whole.

### CROSS-REFERENCE TO RELATED APPLICATION

This application claims priority to U.S. Provisional Application No. 63/589,434, filed on Oct. 11, 2023. The disclosure of the prior application is considered part of and is incorporated by reference in the disclosure of this application.

### BACKGROUND

This specification relates to augmenting machine learning models. This specification further relates to generating embeddings for machine learning models.

### SUMMARY

In general, one innovative aspect of the subject matter described in this specification can be embodied in methods that include the actions of obtaining a set of features including two or more features, generating an embedding of each feature in the set of features, aggregating the embedding of each feature in the set of features to create an aggregated embedding representing the set of features as a whole, and augmenting the machine learning model based on the aggregated embedding representing the set of features as a whole.

In general, another innovative aspect of the subject matter described in this specification can be embodied in systems comprising a data storage device, and one or more processors configured to interact with the data storage device and perform, upon execution of instructions, operations that include the actions of obtaining a set of features including two or more features, generating an embedding of each feature in the set of features, aggregating the embedding of each feature in the set of features to create an aggregated embedding representing the set of features as a whole, and augmenting the machine learning model based on the aggregated embedding representing the set of features as a whole.

In general, another innovative aspect of the subject matter described in this specification can be embodied in non-transitory computer readable media storing instructions that, upon execution, cause one or more processors to perform operations that include the actions of obtaining a set of features including two or more features, generating an embedding of each feature in the set of features, aggregating the embedding of each feature in the set of features to create an aggregated embedding representing the set of features as a whole, and augmenting the machine learning model based on the aggregated embedding representing the set of features as a whole.

These and other embodiments can each optionally include one or more of the following features.

In some implementations, generating the embedding based on the set of features comprises constructing a tower configured to generate an n-dimensional vector as output in response to an input, wherein the tower comprises one or more neural networks based on the set of features, and generating the embedding based on the output of the tower.

In some implementations, augmenting the machine learning model comprises incorporating the tower into the machine learning model.

In some implementations, incorporating the tower into the machine learning model comprises incorporating the tower into the machine learning model as a student model and co-training the student model together with the machine learning model.

In some implementations, incorporating the tower into the machine learning model comprises adding the tower to a teacher model of the machine learning model, obtaining one or more embeddings based on the teacher model, and transferring the obtained embeddings to one or more student models configured to generate the embedding.

In some implementations, the set of features includes campaign features.

In some implementations, the campaign features comprise one or more of name, keywords, assets, landing pages (LPs).

In some implementations, each feature in the set of features corresponds to a unigram or a bigram or a full string.

In some implementations, the campaign features comprise one or more of a campaign name and a set of one or more digital component groups.

In some implementations, each digital component group of the set of one or more digital component groups comprises one or more of a set of keywords, a set of assets, and a set of LPs.

In some implementations, generating the embedding based on the set of features comprises generating multiple embeddings based on multiple large language models (LLMs), wherein each respective embedding of the multiple embeddings is generated for a respective feature of subset of features of the set of features, and aggregating the multiple embeddings to generate the embedding.

In some implementations, generating the embedding based on the set of features comprises generating multiple embeddings based on multiple LLMs, wherein each respective embedding of the multiple embeddings is generated for the set of features, and aggregating the multiple embeddings to generate the embedding.

In some implementations, generating the embedding based on the set of features comprises pre-training a dual encoder LLM based on a score, and generating the embedding based on the pre-trained dual encoder LLM.

In some implementations, generating the embedding based on the set of features comprises constructing a dual encoder LLM based on a teacher model with cross attention, and generating the embedding based on the pre-trained dual encoder LLM.

Some implementations further comprise pre-training the teacher model.

Some implementations further comprise combining, into the machine learning model, one or more large user models.

In some implementations, the machine learning model is optimized for a digital-component-related task.

In some implementations, the machine learning model is a large language model, and wherein the machine learning model is generated to combine one or more of the following one or more campaigns, one or more users, or one or more queries.

In some implementations, the machine learning model is pre-trained with one or more of the following tasks scoring, generating, masked language modelling.

Particular embodiments of the subject matter described in this specification can be implemented so as to realize one or more of the following advantages. The techniques discussed in this specification enable training of models with reduced processing resource requirements (e.g., memory and/or computing power) based on the use of embeddings. Compared to providing to a model a large number of individual features, which would require processing of the large number of features independently, using aggregated embeddings representing a combination of features as a whole, can reduce the dimensionality of the training task and, thus, can reduce processing resource requirements. The embeddings can be configured to represent semantic data and to reduce the dimensionality of feature vectors, whereas previous solutions did not take into account semantic information and/or were based on models that prioritized performance/convergence rather than semantics. The techniques discussed in this specification combine semantics with a reduction in dimensionality of the feature space.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for augmenting machine learning models.

FIG. 2A is a flow chart of an example method for augmenting a machine learning model.

FIG. 2B is a flow chart of an example method for determining targeting goals and predicted user action metrics.

FIG. 3A illustrates co-training a campaign tower.

FIG. 3B illustrates fine tuning a dual-encoder large language model.

FIG. 3C more generally illustrates a basic dual-encoder setup.

FIG. 4 is a block diagram of an example computer system 400 that can be used to perform the method described with respect to FIGS. 2A and 2B.

Like reference numbers and designations in the various drawings indicate like elements.

### DETAILED DESCRIPTION

This specification describes embeddings and techniques for augmenting machine learning models. Machine learning models can be augmented by embeddings. An embedding is a relatively low-dimensional space into which high-dimensional vectors can be translated. Embeddings can improve machine learning on large inputs like sparse vectors, e.g., representing words. An embedding captures semantics of an input by placing semantically similar inputs close together in the embedding space. An embedding can be learned and reused across different machine learning models.

In general, an embedding layer of a neural network can be used to embed features in a feature/embedding space corresponding to the embedding layer. A feature can be an attribute or property that is shared by independent units on which analysis or prediction is to be performed. The independent units can be groups of words in a vocabulary or image pixels that form parts of items, such as images and other documents.

For example, the independent units can include campaigns. Campaigns are entities that encapsulate a set of usually related digital component groups related to similar items or services. The sets typically contain rich semantic signals related to, for example, an area corresponding to a campaign, corresponding items, target demographics, etc. Campaign features can include, for example, digital component groups, keywords, graphical and/or text assets (e.g., headline text), and other related features (e.g., landing page features, such as title terms, salient terms, URLs).

Campaigns can be represented in different ways. For example, a campaign can be constructed in a non-structured (or “flat”) manner with a set of features such as campaign name, a set of keywords used in the campaign, a set of assets used in the campaign, and a set of landing pages (“LPs”) in the campaign. The sets can be large sets containing substantially all keywords, assets, and LPs in a respective campaign. In another example, a campaign can be constructed in a structured manner with a set of features such as a campaign name and a set of digital component groups. Each digital component group can be constructed with a set of features including a set of keywords, a set of assets, and a set of LPs in that respective digital component group.

An algorithm for training embeddings can be executed by a neural network processor to map features to embedding vectors. Embeddings can be learned separately from other layers of a neural network for which the embeddings are to be used, such as when embeddings are pre-trained. For example, an algorithm can be used by the neural network processor to compute embeddings by processing information about discrete input features to determine a mapping or placement of similar inputs to embedding vectors that are geometrically close in the embedding space. In some cases, the process of computing embeddings can represent a technique for feature learning or feature engineering that allows a system to automatically discover representations needed for feature detection from raw input data.

As used throughout this document, and in the context of machine learning and language models, the term “tower” typically refers to a component of a neural network architecture. A tower represents a computational block or module within a neural network that performs a specific subtask or operation. Subtasks are often arranged hierarchically, with each tower handling a different aspect of the overall computation. The output of one tower may serve as input to another tower, allowing for the composition of complex computations. In the context of language models, towers are commonly used in architectures like the Transformer model. In such models, a tower can represent a self-attention mechanism, a feed-forward neural network layer, or any other building block that contributes to the overall language processing capability. Multiple towers can be stacked on top of each other to form a deep neural network. The use of towers may allow for parallelization and more efficient training of deep neural networks. By breaking down the computation into smaller, more manageable units, it can become easier to distribute workload across multiple processing units or devices, such as graphics processing units (GPUs) or tensor processing units (TPUs). This can enable faster training and inference times for large-scale language models.

As used throughout this document, the terms “student model” and “teacher model” are used in the context of transfer learning and knowledge distillation. The term “teacher model” typically refers to a more complex and/or proven model which has been trained on a sufficiently large dataset pertaining to a specific domain. A teacher model can be used in training a student model. In comparison to a teacher model, the term “student model” typically refers to a less complex model which is trained based on knowledge inherent to a trained teacher model. A student model can be trained to capture the knowledge present in the teacher model in order to generate a more compact and efficient representation without negatively affecting its performance. The process of using a teacher model to train a student model can be referred to as knowledge distillation. In this process a student model can be trained to emulate a teacher model's behavior by learning from its predictions and/or internal representations. A teacher model's output, for example, class probabilities in classification tasks or hidden representations of intermediate layers, can be used for this purpose.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

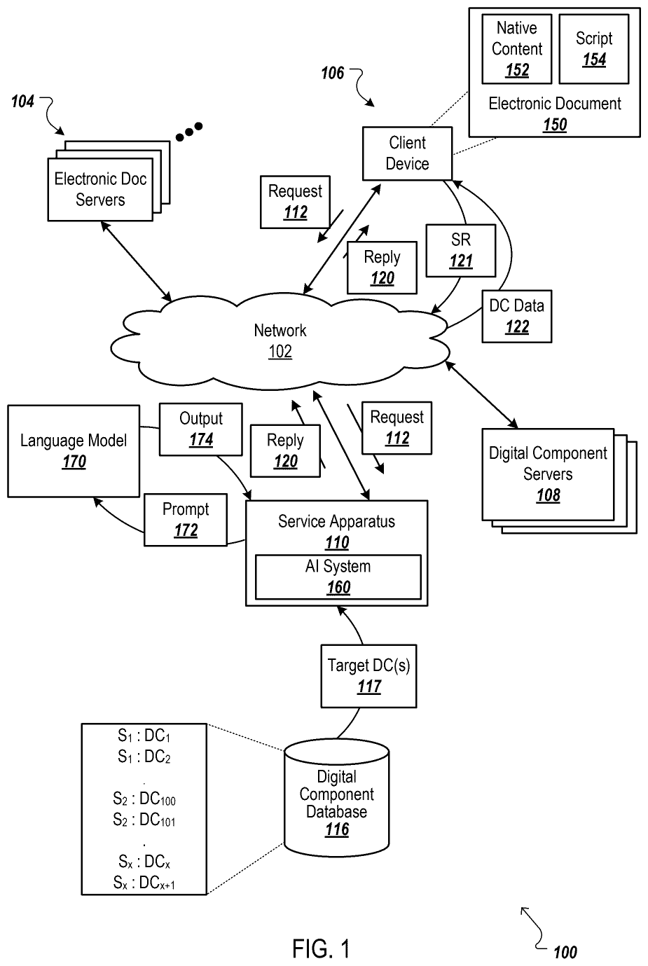

FIG. 1 is a block diagram of an example environment in which one or more target digital components can be presented, according to an implementation of the present disclosure. As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

The example environment 100 includes a network 102, such as a local area network (LAN), a wide area network (WAN), the Internet, or a combination thereof. The network 102 connects electronic document servers 104, client devices 106, digital component servers 108, and a service apparatus 110. The example environment 100 may include many different electronic document servers 104, client devices 106, and digital component servers 108.

A client device 106 is an electronic device capable of requesting and receiving online resources over the network 102. Example client devices 106 include personal computers, gaming devices, mobile communication devices, digital assistant devices, wearable devices (e.g., smart watches), augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include the outputs of a language model, web pages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) includes a script (e.g., script 154) that references the service apparatus 110, or a particular service provided by the service apparatus 110. In these situations, the script is executed by the client device 106 when the given electronic document is processed by the client device 106. Execution of the script configures the client device 106 to generate a request for digital components 112 (referred to as a “component request”), which is transmitted over the network 102 to the service apparatus 110. For example, the script can enable the client device 106 to generate a component request 112 that is packetized and includes a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, e.g., the target digital components 117 or other digital components from the database 116, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., Uniform Resource Locator (URL)) to an electronic document (e.g., a webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, and a type of device at which the digital component will be displayed, such as a mobile device or tablet device). Component requests 112 can be transmitted, for example, over a packetized network.

The service apparatus 110 includes an artificial intelligence system 160 that implements one or more language model neural networks 170, also referred to simply as “language models,” which can include large language models. A large language model (“LLM”) is a model that is trained to generate and understand human language and/or computer code. LLMs are trained on massive datasets of text and/or code, and they can be used for a variety of tasks. For example, LLMs can be trained to translate text from one language to another; summarize text, such as web site content, search results, news articles, or research papers; answer questions about text, such as “What is the capital of Georgia?”; create chat bots that can have conversations with humans; and generate creative text, such as poems and stories (in a natural language) and computer code (in a programming language).

In some implementations, the language model 170 is pre-trained, i.e., trained on a language modeling task that does not require providing evidence in response to user questions, and the service apparatus 110 (e.g., using AI system 160) causes the language model 170 to generate output sequences according to pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

The language model 170 can be configured through training to perform any kind of language modeling tasks, i.e., can be configured to receive any kind of input prompt 172, also referred to simply as “prompt,” and to generate any kind of output sequences 174, also referred to simply as “output,” based on the input prompt 172. Typically, the AI system 160 receives a prompt 172 that is submitted to the language model 170 and causes the language model 170 to generate the output 174 that is a response to the prompt 172.

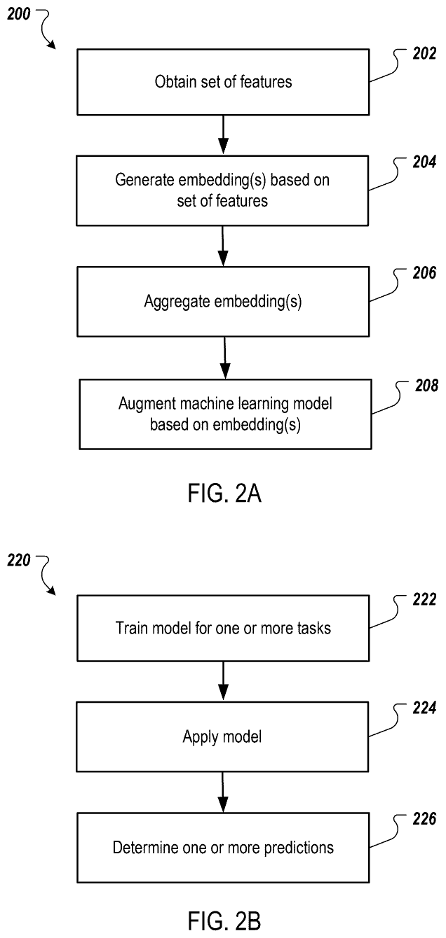

FIG. 2A is a flow chart of an example method 200 for augmenting a machine learning model. The method 200 is described based on an example in which a large campaign model is augmented. The method 200, however, is applicable to augmenting models of various kinds and in various domains.

At step 202, a set of features is obtained. In one example, the set of features are campaign features representing a campaign. They can include a campaign name, a set of keywords used in the campaign, a set of assets used in the campaign, and a set of LPs in the campaign. The sets can be large sets containing substantially all keywords, assets, and LPs in a respective campaign. Each feature in the set of features can, for example, correspond to a unigram or a bigram or the full string. In some implementations, the set of features includes two or more features.

In another example, a campaign can be constructed in a structured manner with a set of features such as a campaign name and a set of digital component groups. Each digital component group can be constructed with a set of features including a set of keywords, a set of assets, and a set of LPs in that respective digital component group.

At step 204, an embedding is generated based on the set of features. The embedding can be generated using one or more techniques, including a bag of words approach, based on large language models, based on a large campaign model, and based on a large bidding language model, or other suitable model, models, or combination thereof. Multiple embeddings can be generated based on one or more of the aforementioned techniques, and one or more machine learning models can be augmented based on one embedding or based on multiple embeddings. In some implementations, the method includes generating an embedding of each feature in the set of features. In some implementations, generating the embedding includes sub-steps of combining the features into a set of features and generating the embedding for the set of features. In such implementations one holistic embedding can be generated for a full set of features.

At step 206, the embedding of each feature in the set of features is aggregated to create an aggregated embedding representing the set of features as a whole. Different ways of aggregating embeddings are described in further detail below.

At step 208, the machine learning model is augmented based on the generated embedding or embeddings. In particular, augmenting the machine learning model can include augmenting the machine learning model based on the aggregated embedding representing the set of features as a whole. The augmented machine learning model is configured to make use of the semantics represented by the embedding or embeddings.

FIG. 2B is a flow chart of an example method 220 for determining one or more distribution goals and/or one or more predicted user action metrics. The method 220 uses language embeddings of an LLM to determine the one or more distribution goals and/or the one or more predicted user action metrics (e.g., application install, item acquisition, or other pre-specified user action). In particular, the method 220 can be configured to use the augmented machine learning model (e.g., the model 340) obtained with method 200 as described in this specification. Example embeddings 312, 322, 362, and 382 are described further below.

At step 222, the model is trained for one or more tasks. The one or more tasks can include scoring, generation, and/or mask language models (MLM). Individual options for training the model are described in more detail further below.

At step 224, the model is applied to one or more tasks. A task can include, for example, value-based bidding (VBB). Value-based bidding enables increasing or maximizing of total value of user actions generated by a campaign.

At step 226, a prediction is generated. In some implementations, the prediction is made in terms of distribution goals and/or predicted user action metrics.

In some implementations, a bag of words approach is used to construct a semantic embedding. The machine learning model is augmented with an additional campaign tower including one or more layers of neural networks (e.g., feed-forward networks, residual networks), which is constructed based on the campaign features. In some implementations, a machine-learning-based predictive model or a model employing predictive neural networks is used. The campaign features can be in the form of n-grams (e.g., unigrams, bigrams) or full strings.

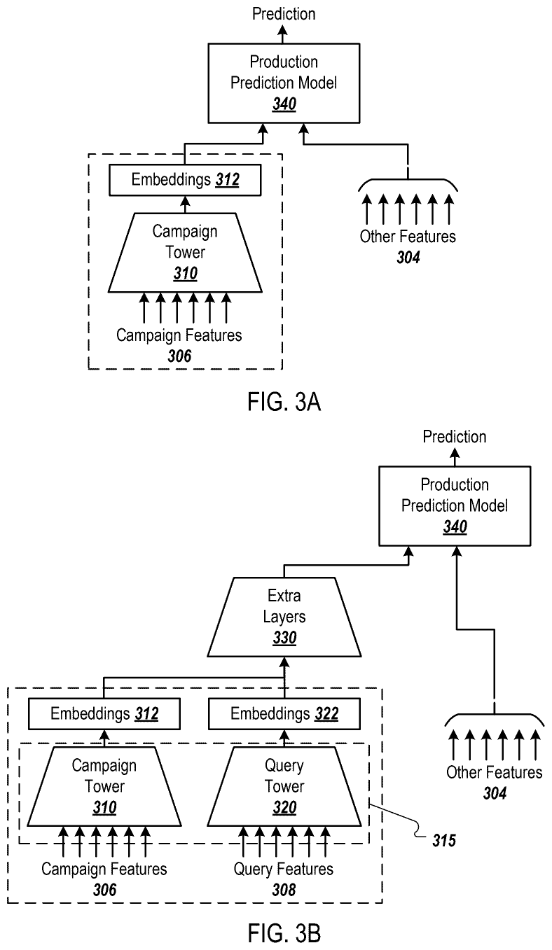

FIG. 3A illustrates co-training a campaign tower 310. The campaign tower 310 is configured to output an n-dimensional output vector. This output vector is used as the campaign embedding 312. The campaign tower 310 is then incorporated into a machine learning model (e.g., Production Prediction Model) 340 and co-trained with the rest of the machine learning model 340, for example with the same label and loss. The machine learning model 340 may be provided with other features 304 (i.e., other than the campaign features 306, which are fed into the campaign tower 310).

Typically, the highest gains (e.g., highest accuracy) can be achieved by co-training a single model with all features. However, this can lead to inefficiencies in serving due to the very large size of the resulting model, which is typically not suitable for online mode. One way to address this includes co-training a student model based on a teacher model, in which a relatively light-weight student model can be optimized for serving (online) and trained based on output from a more complex teacher model (offline). The teacher model can be a purely offline model which can be pre-trained for accuracy and using a larger data set. The student model is trained for speed in order to minimize a gap in accuracy between the teacher model and the student model while, e.g., maintaining or not exceeding a size restriction on the student model. In another approach, a baseline model can be increased in size and resulting gains (e.g., latency, training speed) can be measured in order to determine whether an increase in size would result in sufficient gains.

In some implementations, the campaign tower is part of the student model. In some implementations, a very large campaign tower is added to a teacher model. Embeddings generated using the teacher model are stored and transferred to student models which are configured to generate embeddings using larger capacity towers. This approach may lead to efficiency gains based on the embeddings being shared between different student models. Generally, models can provide more accurate results and better prediction when there is more training data available. For example, for small campaigns with little traffic or for new campaigns, there may not be enough data available to achieve accurate results and/or good prediction from the outset. In such cases, even though there is not much historic data and/or current data available, utilizing the external embeddings that might be generated by large language models or higher capacity teacher models can improve the results.

In some implementations, offline inference could be performed on the campaign tower. The offline inference is performed at regular intervals (e.g., daily, weekly, monthly) to refresh the embeddings. The embedding, for example, in the form of the output vector of the tower, is looked up at serving time. This may lead to efficiency gains, too.

In some implementations, a rich campaign embedding is generated based on large language models (e.g., “multitask unified model”, MUM.) This approach is based on the reuse of existing models and on a large campaign model. Here, different models can be tested and size, performance, accuracy, gains, etc. can be compared.

In a first step, campaign embeddings are generated based on existing large language models in order to generate embeddings for entities inside the campaign. These embeddings are aggregated to generate a campaign embedding for an entire campaign. This is compatible with both the flat and structured representations of campaigns. In one implementation, a (lightweight model) pipeline is used with one or more extensions. Two different approaches for aggregating embeddings are described in the following.

In a first approach, embeddings are generated for each digital component group and are aggregated at the campaign level. This first approach looks at the whole campaign holistically and generates an embedding taking all factors into account. The approach can, in particular, be used with relatively smaller models. Generally, the resulting embeddings are highly accurate for each digital component group. In particular, this first approach can be useful in cases where the digital component groups are at least partly inhomogeneous. In such cases, the resulting embeddings can be screened for similarity and outliers can be removed (e.g., when most embeddings are similar, except for a few) before aggregating the embeddings at campaign level. Additionally, or alternatively, the resulting embeddings can be screened for the existence of subgroups, where embeddings within each subgroup are relatively similar, and where embeddings of different subgroups are relatively dissimilar. The resulting (similar) embeddings of each subgroup can then be separately aggregated. This can allow determining whether the digital component groups cover similar products.

In a second approach, the campaign is formatted as a single digital component group by taking the union of all keywords and assets from different digital component groups inside the campaign, and an embedding is generated for the single digital component group. This second approach can be advantageous when a campaign covers a wider set of items (e.g., partly inhomogeneous). The approach allows for the use of larger models and produces an embedding that covers all products in the single digital component group without determining whether the products are homogeneous or not. Compared to the previous example in which embeddings are separately generated for each digital component group and are aggregated at the campaign level, this second approach is less complex.

It has been found that the first and the second approach often provide relatively similar performance/results. Depending on the individual campaign, the first or the second approach can offer improved embeddings over the other.

In a second step, a model is pre-trained or fine-tuned based on a task. A particular task can be different for different campaigns, for example, a predetermined user action, value, number of impressions, etc. In some implementations, the task is defined as an auto-bidding task or a value-based-bidding task. The auto-bidding or value-based-bidding is configured to optimize the respective goal.

FIG. 3B illustrates fine tuning a dual-encoder large language model 315. In some implementations, an existing dual encoder LLM 315 is fine-tuned to score user actions (e.g., clicks, long clicks, conversations) based on campaign+query→user action. A first example model has two towers, a query tower 320 and a digital component group tower (e.g., Campaign Tower) 310. Digital component group embeddings can be (pre-) generated using a digital component group encoder, digital component group embeddings can be aggregated using a campaign id, and campaign embeddings 312 can be produced by normalization. The digital component group tower 310 is provided with the campaign features 306. Query features 308 can include, for example, query text (e.g., spell-checked), query-based salient terms, task intents, and other related features (e.g., optionally, query unigrams, query language). The query embedding 322 can be (pre-) generated, for example, based on pre-defined query clusters. The fine-tuning can further include additional adapt layers 330 and/or be based on additional/other features 304.

A second example model is based on impressions instead of clicks. Compared to the first example model, a different dependent variable and/or loss function can be chosen and datasets can be fine-tuned. A third example model is a large language model, preferably a MUM (e.g., DE MUM). For a campaign representation constituting keywords and documents, keyword embeddings can be generated using a query tower and document embeddings can be generated using a document tower. Keyword embeddings and document embeddings can be concatenated to obtain the campaign embedding.

Other example models can be trained based on different objectives, loss functions, and training sets.

FIG. 3C more generally illustrates a basic dual-encoder model 300. In the illustrated example, the encoder 360 represents campaigns (or, more generally, “documents”) and the encoder 380 represents queries. In some implementations, the encoder 360 is utilized to generate embeddings for a given campaign (inference). The generated embeddings are sent to the prediction model 340 either directly (see, e.g., FIG. 3A) or through extra layers 330 (see, e.g., FIG. 3B).

An already existing dual encoder that is pre-trained on the same domain can be directly adopted for this task as-is. Alternatively, the dual encoder can be adapted further to a particular task at hand. In corresponding implementations, the weights of an already-trained dual encoder are updated by further training on the specific task at hand using a dataset specifically collected for this specific task. In some examples, the specific dataset includes one-year click and conversion events from logs.

In some implementations, a full cross-attention model is pre-trained. In this context, cross-attention refers to a setup in which all features including query and campaign are given as input to the model inside a same sequence as opposed to sending the query sequence to one encoder and the campaign sequence to a separate encoder. In this pre-training stage, extra data and objectives from the task at hand are included, besides data and tasks (see above). When the model is fully trained, it is distilled to a dual encoder. In some examples, distillation is executed by taking the encoder (weights) from the model to “warm-start” the encoders 360 and 380 of the dual-encoder model 300 of FIG. 3C. The resulting (new) dual encoder is then utilized for inference of campaign embeddings.

In one example, the dual encoder model 300 (including, e.g., encoders 360, 380) is fine-tuned from a dual encoder checkpoint. In another example, the dual encoder model 300 can be distilled from a cross-attention checkpoint. In yet another example, a cross-attention teacher model (e.g., from MUM) can be fine-tuned and distilled into a dual encoder model 300. Fine tuning can be based on, for example, one-year click events from logs and aggregated to (query, campaign)→average user action.

In another example, other measures can be used. With respect to loss, for example, an in-batch softmax, cross-entropy loss, Poisson LogLoss (PLL), or generalizable mixture-of-experts (GMoE) can be used. Generating hard negatives and adding the same to the training set can further improve the results. In another example, a rank loss on top of pairs (positive vs. hard negatives) or lists (1 positive, k hard negatives) can be used. Hard negatives can be obtained by collecting examples of<Query, Campaign>where the model predicts high scores but where user action=0.

In some implementations, queries are clustered into high-level intents that users have. This allows for offline generation of intents. As a threshold matter, user intents tend to change relatively slowly over time so that query clusters and campaign embeddings can be pre-computed and pre-loaded. Query embeddings are typically generated online, and rather light-weight models are used for query embeddings. Query clusters can be used to obtain an intent of a user. Embeddings for query clusters can be pre-computed and aggregated for making them available offline. This can be implemented in a similar manner as campaign aggregation described above. The precomputed embeddings for query clusters can be used as a substitute for online-inferred query embeddings to avoid online inference and reduce latency.

In some implementations, a large language model is generated to combine campaigns, users, and current queries. Cross-attention (see above) between these entities can be used to further improve results. The model can be pre-trained with one or more of the following tasks. Scoring can be based on (campaign, user, query)→user action (e.g., “pconvs” or “longclick”.) Generation can be based on (campaign, user, conversion)→query or on (query, user, conversion)→campaign (e.g. using keyword, asset, LP title, LP salient term.) Masked language modelling (“MLM”) can be done by masking middle queries and making a prediction in order to only include relevant queries. MLM can also be based on campaign features. Based on a given query, (consecutive) tokens can be masked in an asset or LP title. An illustrative example includes: {asset=“Best hiking shoes for men”, LP title=“XYZ hiking shoes”, query=“shoes for hiking”}, with asset=“Best (X) shoes for men”→ output=<X> hiking. There may be additional tasks from the user models with queries and user actions (e.g., scoring, generation, MLM.) At least a portion of the data (e.g., embeddings, models, training data) are generated offline and are subject to ageing. In some implementation, several steps are performed to ensure freshness of data.

For example, in a first step, embeddings are generated using a current snapshot of a campaign (e.g., current keywords, assets, name.) The embeddings are stored in a campaign sstable, each campaign having a unique key (e.g., campaign_id) and a value (e.g., “campaign semantic embedding.”) A respective model (e.g., MUM, see above) will look up the embedding based on an event from the sstable. These embeddings are used in an initial phase and gains around campaign data collection time are primarily focused on. This setup is relatively simply compared to other approaches. As campaign features can change frequently, generating embeddings from a single snapshot can lead to the embeddings being not up to date with the most current campaign features.

In a second step, for “front-fill”, a pipeline regularly extracts up-to-date campaign data (e.g., once per day, several times per day) and corresponding embeddings are generated. For “backfill”, historical (e.g., daily) snapshots are looked up from archive campaign tables and corresponding campaign embeddings are generated accordingly. These (e.g., daily) campaign embeddings can be stored per event in the dataset.

In some implementations, the client device 106 is configured to provide additional functionality, for example, presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

As a particular example, the language model 170 can be configured to perform a summarization task. In this example, the AI system 160 receives the prompt 172, e.g., either as part of or in addition to a component request 112 or another request for an output 174, from a user of the client device 106. The prompt 172 includes or references a set of online sources and, optionally, an instruction that requires the AI system 160 to generate a summarization of the set of online sources. To initiate creation of the output 174, the AI system 160 submits the received prompt 172 to the one or more language models 170, which use the prompt 172 to evaluate the information found at the online sources specified in the prompt 172 and generate the output 174 that summarizes the information.

The service apparatus 110 chooses digital components (e.g., third-party content, such as video files, audio files, images, text, gaming content, augmented reality content, and combinations thereof, which can all take the form of advertising content or non-advertising content), e.g., the target digital components 117, that will be presented together with the output 174 that is a response to the prompt 172.

In some implementations, a digital component is selected in less than a time threshold to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

As another example, as the delay in providing the digital component to the client device 106 increases, it is more likely that a topic that the digital component relates to is no longer relevant to the present conversation turns between the user and the language model 170 when the digital component is delivered to the client device 106. As a result, a user's experience with the AI system 160 is negative impacted.

Further, delays in providing the digital component can result in a failed delivery of the digital component. For example, if a conversation is no longer ongoing at a client device 106 and the prompt 172 has become obsolete when the digital component is provided.

In some implementations, the service apparatus 110 is implemented in a distributed computing system that includes, for example, a server and a set of multiple computing devices that can operate together to execute the operations of the language model 170.

In particular, the plurality of available digital components is stored in a database, e.g., the digital component database 116 of FIG. 1, where they are indexed to different stages within respective user journeys for performing a computer-implemented task. In brief, each user journey represents a process during which a user performs actions (or operations) to accomplish a final goal of the task; each user journey is partitioned into an ordered sequence of stages during which different actions are performed by the user.

As illustrated in FIG. 1, the digital component database 116 stores these available digital components in key-value pairs, where the keys represent the different stages of the user journeys, and the values represent available digital components. Each key (stage) can reference the corresponding values (digital components) that are mapped to the key. The digital component database 116 can have any of a variety of known data structure to store keys and the keys'associated values. These available digital components can be received by the service apparatus 110 from one or more digital component providers, e.g., third-party content providers, for example, from multiple digital component provider that corresponds respectively to the multiple different stages.

As illustrated, digital components DC₁₋₂ are stored in association with a first stage S₁, digital components DC₁₀₀₋₁₀₁ are stored in association with a second stage S₂, digital components DCₓ₋ₓ₊₁ are stored in association with a third stage Sₓ, and so on. The digital component database 116 thus stores a mapping between each of the different stages within the user journey and the corresponding digital components that are associated with the stage. Each stage within the user journey can map to the same or different numbers (or categories) of digital components. For example, different stages can map to non-overlapping or partially overlapping subsets of all of the available digital components stored in the digital component database 116.

The identification of the eligible digital component to be presented together with the output 174 that is a response to the prompt 172 includes identifying, by the service apparatus 110 and based on the prompt 172, a target stage within the user journey, and then selecting one or more digital components that are mapped to the target stage as eligible digital component for presentation. The identification of target stage includes using the intermediate embeddings generated by one or more intermediate neural network layers of the language model 170 during the processing of the prompt 172, as will be described further below.

Generally, the service apparatus 110 can select any number of target digital components that are mapped to the identified target stage. In some implementations, the service apparatus 110 can then generate and transmit, over the network 102, reply data 120 (e.g., digital data representing a response) that enable the client device 106 to integrate the set of target digital components into the output 174, such that the set of target digital components (e.g., target third-party content) and the content of the output 174 generated by the language model 170 are presented together at a display of the client device 106.

In some implementations, the client device 106 executes instructions included in the reply data 120, which configures and enables the client device 106 to obtain the set of target digital components from one or more digital component servers 108. For example, the instructions in the reply data 120 can include a network location (e.g., a URL) and a script that causes the client device 106 to transmit a server request (SR) 121 to the digital component server 108 to obtain a given winning digital component from the digital component server 108. In response to the request, the digital component server 108 will identify the given target digital component specified in the server request 121 (e.g., within the database 116 storing multiple digital components) and transmit, to the client device 106, digital component data (DC Data) 122 that presents the given target digital component together with the output 174 at the client device 106.

When the client device 106 receives the digital component data 122, the client device will render the digital component (e.g., third-party content), and present the digital component at an appropriate location. For example, the script 154 can create a walled garden environment, such as a frame, that is presented within, e.g., beside, the native content 152 of the electronic document 150. In some implementations, the digital component is overlaid over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented. For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices that are interconnected and identify and distribute digital component in response to requests 112. The set of multiple computing devices operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP1-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks that are then assigned among computing devices within the set of multiple computing devices. For example, different computing devices in the set can each analyze a different portion of the digital component database 116 to identify various digital components having distribution parameters that match information included in the component request 112. In some implementations, each given computing device in the set can analyze a different data dimension (or set of dimensions) and pass (e.g., transmit) results (Res 1-Res 3) of the analysis back to the service apparatus 110. For example, the results provided by each of the computing devices in the set may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results received from the set of multiple computing devices and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an artificial intelligence system 160 configured to autonomously generate digital components, either prior to a request 112 (e.g., offline) and/or in response to a request 112 (e.g., online or real-time). As described in more detail throughout this specification, the artificial intelligence (“AI”) system 160 can collect online content about a specific entity (e.g., digital component provider or another entity) and summarize the collected online content using one or more language models 170, which can include large language models.

A large language model (LLM) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens.

The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. ar Xiv preprint ar Xiv: 2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

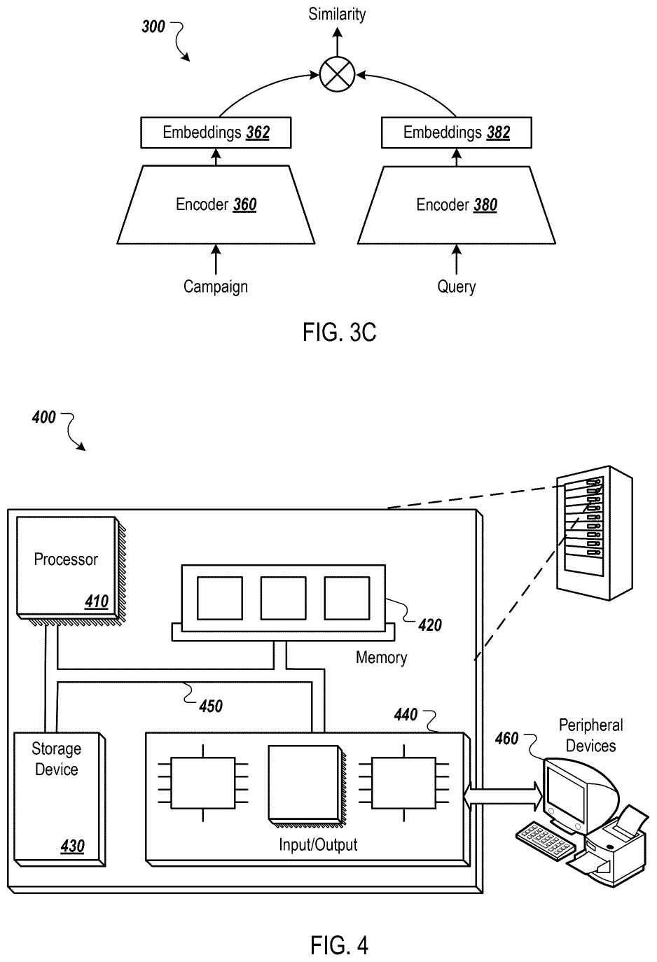

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for augmenting a machine learning model, the method comprising:
obtaining a set of features including two or more features;
generating an embedding of each feature in the set of features;
aggregating the embedding of each feature in the set of features to create an aggregated embedding representing the set of features as a whole; and
augmenting the machine learning model based on the aggregated embedding representing the set of features as a whole.

2. The method of claim 1, wherein generating the embedding based on the set of features comprises:
constructing a tower configured to generate an n-dimensional vector as output in response to an input, wherein the tower comprises one or more neural networks based on the set of features; and
generating the embedding based on the output of the tower.

3. The method of claim 2, wherein augmenting the machine learning model comprises incorporating the tower into the machine learning model.

4. The method of claim 3, wherein incorporating the tower into the machine learning model comprises incorporating the tower into the machine learning model as a student model and co-training the student model together with the machine learning model.

5. The method of claim 2, wherein incorporating the tower into the machine learning model comprises:
adding the tower to a teacher model of the machine learning model;
obtaining one or more embeddings based on the teacher model; and
transferring the obtained embeddings to one or more student models configured to generate the embedding.

6. The method of claim 1, wherein the set of features includes campaign features.

7. The method of claim 6, wherein the campaign features comprise one or more of: name, keywords, assets, landing pages (LPs).

8. The method of claim 1, wherein each feature in the set of features corresponds to a unigram or a bigram or a full string.

9. The method of claim 6, wherein the campaign features comprise one or more of a campaign name and a set of one or more digital component groups.

10. The method of claim 9, wherein each digital component group of the set of one or more digital component groups comprises one or more of: a set of keywords, a set of assets, and a set of LPs.

11. The method of claim 1, wherein generating the embedding based on the set of features comprises:
generating multiple embeddings based on multiple large language models (LLMs), wherein each respective embedding of the multiple embeddings is generated for a respective feature of subset of features of the set of features; and
aggregating the multiple embeddings to generate the embedding.

12. The method of claim 1, wherein generating the embedding based on the set of features comprises:
generating multiple embeddings based on multiple LLMs, wherein each respective embedding of the multiple embeddings is generated for the set of features; and
aggregating the multiple embeddings to generate the embedding.

13. The method of claim 1, wherein generating the embedding based on the set of features comprises:
pre-training a dual encoder LLM based on a score; and
generating the embedding based on the pre-trained dual encoder LLM.

14. The method of claim 1, wherein generating the embedding based on the set of features comprises:
constructing a dual encoder LLM based on a teacher model with cross attention; and
generating the embedding based on the pre-trained dual encoder LLM.

15. The method of claim 14, further comprising pre-training the teacher model.

16. The method of claim 1, further comprising:
combining, into the machine learning model, one or more large user models.

17. The method of claim 16, wherein the machine learning model is optimized for a digital-component-related task.

18. The method of claim 16, wherein the machine learning model is a large language model, and wherein the machine learning model is generated to combine one or more of the following: one or more campaigns, one or more users, or one or more queries.

19. The method of claim 18, wherein the machine learning model is pre-trained with one or more of the following tasks: scoring, generating, masked language modelling.

20. A system, comprising:
a data storage device; and
one or more processors configured to interact with the data storage device and perform, upon execution of instructions, operations comprising:
obtaining a set of features including two or more features;
generating an embedding of each feature in the set of features;
aggregating the embedding of each feature in the set of features to create an aggregated embedding representing the set of features as a whole; and
augmenting the machine learning model based on the aggregated embedding representing the set of features as a whole.

21. The system of claim 20, wherein generating the embedding based on the set of features comprises:
constructing a tower configured to generate an n-dimensional vector as output in response to an input, wherein the tower comprises one or more neural networks based on the set of features; and
generating the embedding based on the output of the tower.

22. The system of claim 21, wherein augmenting the machine learning model comprises incorporating the tower into the machine learning model.

23. The system of claim 22, wherein incorporating the tower into the machine learning model comprises incorporating the tower into the machine learning model as a student model and co-training the student model together with the machine learning model.

24. The system of claim 21, wherein incorporating the tower into the machine learning model comprises:
adding the tower to a teacher model of the machine learning model;
obtaining one or more embeddings based on the teacher model; and
transferring the obtained embeddings to one or more student models configured to generate the embedding.

25. The system of claim 20, wherein the set of features includes campaign features.

26-57. (canceled)
